(19) United States
(12) Patent Application Publication
(10) Pub. No.: US 2010/0268709 A1
(43) Pub. Date: Oct. 21, 2010

(54) SYSTEM, METHOD, OR APPARATUS FOR CALIBRATING A RELEVANCE SCORE

(75) Inventor: Alex Cozzi, Sunnyvale, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., a Delaware corporation, Sunnyvale, CA (US)

(21) Appl. No.: 12/427,570

(22) Filed: Apr. 21, 2009

(51) Int. Cl. G06F 17/30

(52) U.S. Cl. 707/728; 707/E17.071

(57) ABSTRACT

Embodiments of methods, apparatuses, devices and systems associated with calibrating one or more relevance scores are disclosed.

### FIELD

Embodiments relate to the field of search engines, and more specifically to calibrating relevance scores for search engine results.

### BACKGROUND

The world wide web includes a wide variety of documents or files, such as web pages, audio files, video files, images, text documents, or the like. Given the large quantity of information, search engines may be desirable to help a user find documents or files that may be of particular interest to that user. In addition, it may be desirable for search engines to employ one or more processes to rank such documents or files to assist in presenting relevant or useful documents to a user in response to a user query. Such ranking processes may, however, not determine the relevance of different types of documents in different ways. Accordingly, it may be desirable to develop one or more systems, processes, or apparatuses to account for the different ways in which the relevance of different types of documents, search results, or files are determined.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a schematic diagram of a system in accordance with an embodiment;

FIG. 2 depicts a plot of determined relevance scores versus user determined grades or rankings for one or more documents, files, or search results;

FIG. 3 depicts determined calibration function based at least in part on the plot depicted with regard to FIG. 2;

FIG. 4 depicts a flow chart representation of a process in accordance with an embodiment; and

FIG. 5 depicts a schematic diagram of a special purpose computing device in accordance with an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, procedures, components or circuits that would be known by one of ordinary skill have not been described in detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

The world wide web includes a wide variety of documents or files, such as web pages, audio files, video files, images, text documents, or the like. Given the large quantity of information, search engines may be desirable to help a user find documents, files, or search results that may be of particular interest to that user. As used herein, a document, file or search result may refer to one or more signals that may be stored in a machine readable format. For example, a document or file may comprise one or more signals representing text, sound, video, images, or the like that may be displayed or played by one or more special purpose computing apparatuses. In an embodiment, it may be desirable for search engines to employ one or more processes to rank such documents, files, or search results to assist in presenting relevant or useful results to a user in response to a search query. For example, a search engine may employ one or more different relevance functions for different types of documents or files. In this example, a search engine may utilize a first relevance function for determining a relevance score of text documents, a second relevance function for determining a relevance score for image files, and so on for any number of file types a search engine may encounter or provide search results for. In an embodiment, those one or more relevance functions may determine relevance scores for their respective types of documents, files, or search results in different manners. Accordingly, under some circumstances, such relevance functions may present difficulties in comparing relevance scores for documents, files, or search results having different types. For example, a numerical score assigned to an image file by a first relevance function may, under some circumstances, not compare directly with a numerical score assigned to a text file by a second relevance function. A relevance score, as user herein, may refer to a quantitative evaluation of a document, file, or search result based at least in part on one or more aspects of that document, file, or search result. For example, a relevance score may comprise a numerical value (e.g. on a predefined scale) determined by a machine or process based at least in part on one or more aspects of a particular document, file or search and may be used at least in part to rank such documents, files, or search results. In this example, a relevance function may analyze one or more aspects of one or more feature vectors associated with particular documents, files, or search results and may determine a numerical relevance score based on such analysis. One example of which may be found in the paper entitled Beyond PageRank: machine learning for static ranking, by Mathew Richardson, et al, presented at the Proceedings of the 15th international conference on World Wide Web. Such ranking processes or relevance functions may, a mentioned above, determine relevance scores for different types of documents, files, or search results in different ways and with different quantitative results. Under some circumstances, the determined relevance scores for different types of documents, files, or search results may pose difficulties for determining relative rankings or scores for the different types of documents, files, or search results. For example, a relevance function for image files may determine a relevance score for a particular image file as a good match for a particular search query, while a relevance function for video files may determine that another, possibly less relevant, search result may be a great match for that particular search query. Accordingly, it may be advantageous to develop a system, apparatus or process for calibrating relevance scores determined by different relevance functions. One way in which this can be accomplished is by employing one or more human or user grades in conjunction with one or more relevance function determined relevance scores.

Returning to the above example, the relevance function for image files may determine a relevance score for a particular image as a good match for one or more query terms, while a human or user grade for that same document may be a great match. Likewise, a relevance function for web pages, documents, or other types of files may also determine a relevance score that may differ from a user ranking of that particular web page, document, or file. Accordingly, it may be desirable to employ human or user grades to at least in part calibrate one or more relevance functions to assist in ranking search results having different types. As used herein a human or user grade may refer to a quantitative and/or qualitative evaluation of a document or file based on one or more aspects of that document, file, or search result and a perceived relation of the document, file, or search result to one or more search queries. For example, a human or user grade may comprise a numerical value representing a perceived quality of a file, document, or search result based at least in part on one or more aspects of the file, document, or search result. In this example, a human or user may evaluate a particular document, file, or search result and assign a grade to that particular document, file or search result in relation to one or more search queries. Accordingly, it may be desirable to develop systems, processes, or apparatuses to account for the different ways in which relevance scores for different types of documents or files are determined. In addition, it may also be desirable to develop systems, processes, or apparatuses to combine and calibrate relevance scores for different types of documents, files, or search results and rank search results based at least in part on those combined calibrated relevance scores. As used herein, calibrate may refer to a system or process to adjust one or more values at least in part so that those values may be compared on a common scale. However, it should be noted that these are merely illustrative examples relating to relevance scores and that claimed subject matter is not limited in this regard.

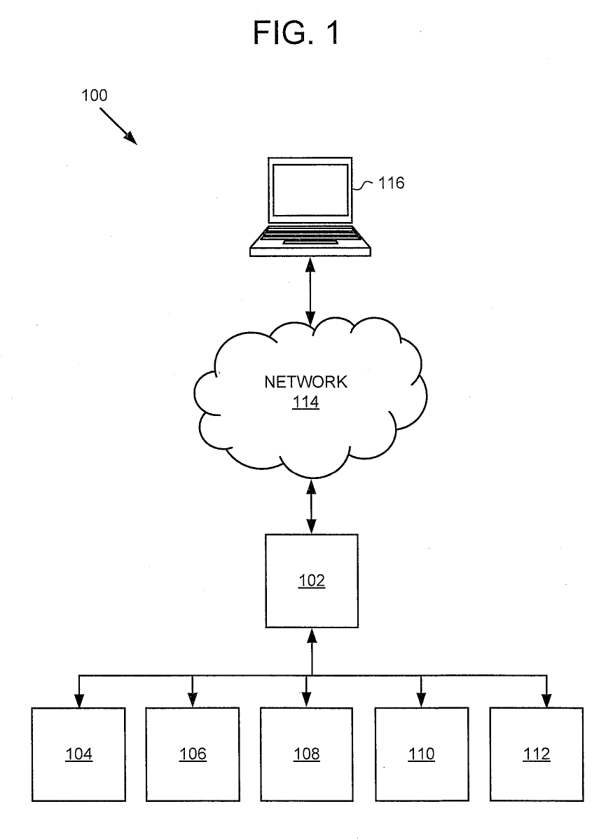

FIG. 1 is a schematic diagram of a system in accordance with an embodiment 100. With regard to embodiment 100, a special purpose computing apparatus 102 may receive one or more relevance function determined relevance scores from one or more other computing apparatuses, such as computing apparatuses 104, 106, 108, 110, and 112, for example. In this example, the received one or more determined relevance scores from a particular computing apparatus may correspond to one or more documents, files, or search results of a particular type. For example, the received one or more determined relevance scores from computing apparatus 104 may be indicative of a relevance of one or more web pages, while the received one or more determined relevance scores from computing apparatus 106 may be indicative of a relevance of one or more digital image files, and so on. In an embodiment, special purpose computing apparatus 102 may likewise receive one or more human or user determined grades or rankings corresponding to documents, files, or search results for which it has received determined relevance scores. For example, computing apparatus 102 may receive user determined grades for a first set of files or documents and may also receive determined relevance scores corresponding to those same documents. While a size of the first set of documents may vary under certain circumstances, such as based on a consistency associated with human or user determined grades, a desirable size for a first set of files or documents may be on the order of a few thousand documents or files having user determined grades. As discussed above, the human or user determined ranking or grade may differ from the relevance function determined relevance scores. Accordingly, special purpose computing apparatus 102 may calibrate the determined relevance scores based at least in part on the received user rankings, based at least in part on a calibration function as discussed more fully below. It should, however, be noted that these are merely illustrative examples relating to relevance scores and user rankings and that claimed subject matter is not limited in this regard.

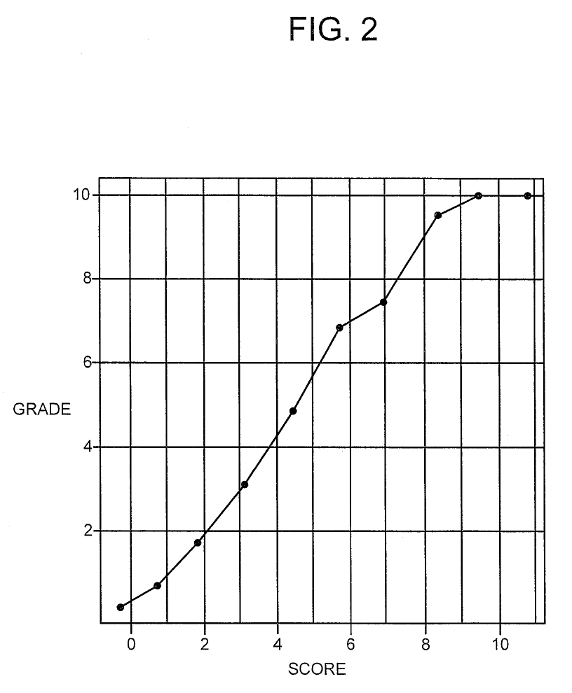

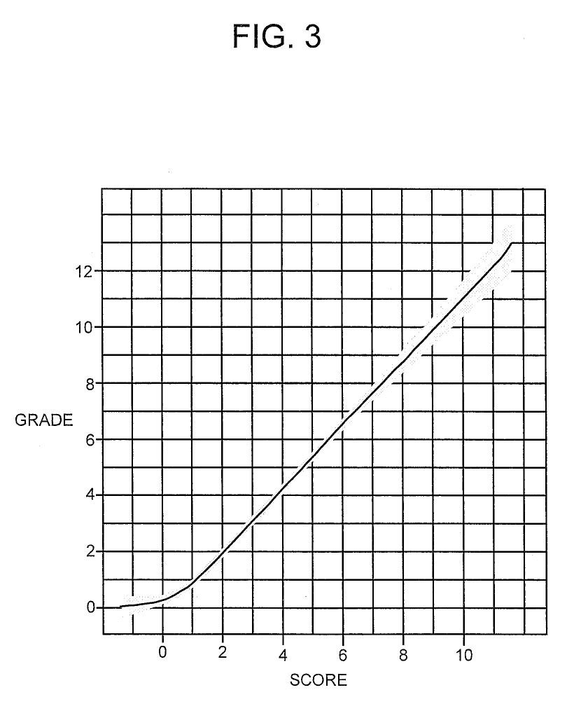

In an embodiment, special purpose computing apparatus 102 may determine a calibration function based at least in part on the human or user grades or rankings and the relevance function determined relevance scores. As used herein a calibration function may refer to a graphical representation of a function derived from one or more values that may under some circumstances be used to calibrate or adjust a relevance function determined relevance score. For example, a calibration function, such as a calibration curve, may comprise a graphical plot of one or more human or user determined grades against one or more relevance function determined relevance scores for one or more documents, files, or search results. In this example, the relationship between a human or user grade or ranking and a relevance function determined relevance score may be employed to at least in part determine one or more calibrated relevance scores. As used herein a calibrated relevance score may refer to a relevance function determined relevance score that has been adjusted based at least in part on a calibration function and/or one or more human or user determined grades or rankings. In this example, it may be advantageous for special purpose computing apparatus 102 to employ a smooth interpolator function, such as linear interpolator, third order splines, or low-order polynomials to determine a calibration curve. In at least one embodiment, a calibration curve may comprise a smooth monotonic curve, such as a curve derived at least in part by employing one or more monotonic interpolation splines. In this embodiment, monotonicity may be desirable at least in part to preserve an original order of any documents within a particular type. For example, at least in part by employing a monotonic function an order of documents before and after a calibration process may at least in part be maintained. In an embodiment, computing apparatus 102 may determine an average for one or more human or user determined grades for one or more documents, files, or search results along with an average for relevance function determined relevance scores for those one or more documents, files, or search results. FIG. 2 depicts a graphical plot of such a calculation, in which the horizontal axis corresponds to relevance function determined relevance scores and the vertical axis corresponds to human or user determined grades. As shown in FIG. 2, a relevance function determined relevance score having a value of 8 may correspond to human grade having a value of approximately 9.0. In this example, such a relevance function determined relevance score may be calibrated or adjusted to a value of approximately 9.0 at least in part so that the relevance function determined relevance score more closely matches the human or user determined grade. With regard to FIG. 3, special purpose computing apparatus 102 may further employ a localized smooth interpolator function, such as third-degree splines, for example, on the curve shown in FIG. 2 to calculate a smooth calibration curve for those human or user determined grades and the relevance function determined relevance scores, In the curve depicted in FIG. 3 the horizontal axis corresponds to relevance function determined relevance scores and the vertical axis corresponds to approximate human or user determined grades. In this example, a relevance function determined relevance score of 6.0 would correspond to an approximate human determined grade of 6.3. Accordingly, a relevance function determined relevance score of 6.0 may, under these circumstances, be calibrated to approximately 6.3 so that the relevance function determined relevance score more closely matches a human or user determined grade. It should, however, be noted that these are merely illustrative examples relating to calibration functions and relevance scores and that claimed subject matter is not limited in this regard.

In an embodiment, special purpose computing apparatus 102 may form additional calibration functions based on additional human or user determined grades or ranks and corresponding relevance function determined relevance scores for additional document, file, or search result types. In this example, special purpose computing apparatus 102 may determine a calibration function for any documents, file, or search result types which have a corresponding relevance function. For example, special purpose computing apparatus 102 may determine a calibration function for web pages, a calibration function for video files, a calibration function for audio files, a calibration function for image files, a calibration function for pdf files, text documents, or the like. By way of example, by determining a calibration function for such a variety of documents special purpose computing apparatus 102 may be able to determine one or more adjusted or calibrated relevance scores for corresponding documents of files based on the determined calibration functions. In this example, special purpose computing platform 102 may be able to determine calibrated relevance scores for additional documents of a corresponding type. For example, if a search query returns a web page having a particular determined relevance score, special purpose computing apparatus 102 may be operable to determine a calibrated relevance score for such a web page based at least in part on a corresponding calibration function. In addition, if calibrated relevance scores are determined for a variety of search results, special purpose computing apparatus 102 may be operable to form a combined or blended ranking of those search results for presentation to a user. For example, search results having different types may now be ranked or listed based at least in part on their respective calibrated relevance scores and not their respective document, file, or search result types. For example, an image file having a calibrated relevance score of 9.5 may be ranked above a text file having a calibrated relevance score of 9.0. In this way search results of different types may be presented to a user as ranked based on their calibrated relevance scores in a blended manner. In this example, this may be performed by adjusting for differences in relevance scores based on different relevance function used to determine their respective relevance function determined relevance scores. For example, relevance scores for a variety of search result types may be calibrated as described above. The results may then be ranked based on their respective adjusted or calibrated relevance scores and presented to a user, such as in a blended list of ranked search results of different types. It should, however, be noted that these are merely illustrative example relating to relevance score, rankings, or calibrated relevance scores and that claimed subject matter should not be limited in this regard.

With regard to FIG. 1, a user may submit a search query via an electronic communications network 114, such as by using computing apparatus 116 and one or more application programs, such as a web browser. In this embodiment, special purpose computing apparatus 102 may receive one or more signals representing the user query via electronic communications network 114. In this embodiment, special purpose computing apparatus 102 may determine one or more search results based at least in part on the one or more signals representing the user query. For example, special purpose computing apparatus 102 may communicate via a network with one or more other computing apparatuses, such as computing apparatuses executing search engine programs, for example. In this example, the one or more other computing apparatuses may return one or more search results to special purpose computing apparatus 102. Such returned search results may include one or more corresponding relevance scores, such as a relevance score determined by one or more relevance functions. In this example, special purpose computing apparatus 102 may employ one or more determined calibration functions, such as a calibration curve determined in the manner described above, to at least in part determine a calibrated relevance score for such search results. Furthermore, special purpose computing apparatus 102 may determine a combined or blended ranking of the search results based at least in part on the calibrated relevance scores. For example, special purpose computing apparatus 102 may re-rank such search results based at least in part on their corresponding calibrated relevance scores. In an embodiment, special purpose computing apparatus 102 may additionally form one or more signals representing the calibrated relevance scores and store those formed signals in a memory device associated with special purpose computing apparatus 102. In addition, special purpose computing apparatus 102 may transmit one or more signals representing the combined or blended ranking of the search results via electronic communication network 114 for display to a user on computing apparatus 116. It should, however, be noted that these are merely illustrative examples relating to calibrating relevance scores and that claimed subject matter is not limited in this regard.

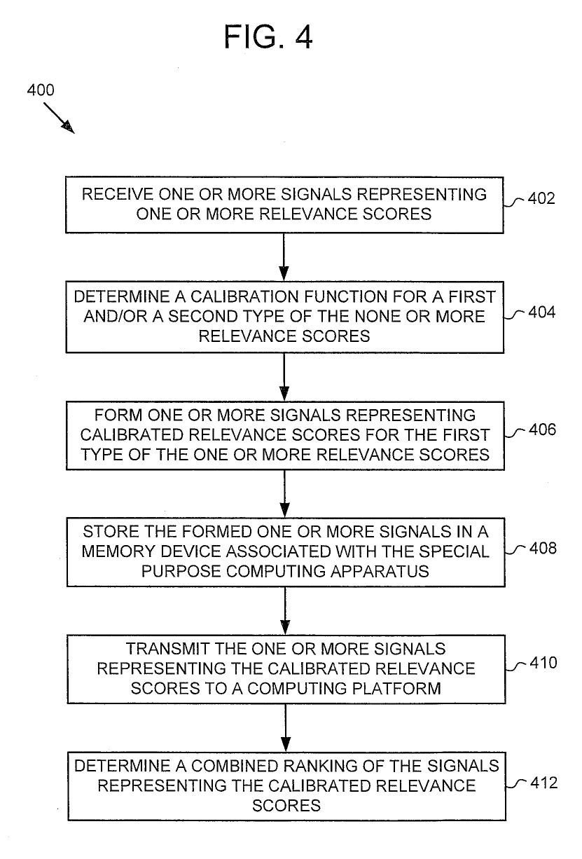

FIG. 4 depicts a flow chart representation of a process in accordance with an embodiment 400. With regard to box 402, a system or process may receive one or more signals representing one or more relevance function determined relevance scores associated with one or more documents from an electronic communication network, such as electronic communication network 114, for example. For example, a system or process may also receive one or more signals representing one or more human or user grades or rankings corresponding to the received one or more relevance function determined relevance scores. With regard to box 404, a system or process may execute instructions on a special purpose computing apparatus to determine a calibration function for a first type of documents, files, or search results corresponding to the one or more relevance scores based at least in part on the first type of the one or more relevance scores and the one or more human or user determined grades or rankings of one or more of the documents, files, or search results. For example, as described above, a system or process may organize signals representing the one or more relevance function determined relevance scores plot those relevance scores relative to signals representing human or user grades or rankings for corresponding documents, files, or search results. In addition, a system or process may operate on the signals representing the one or more relevance function determined relevance scores and the one or more user rankings with an interpolator function, such as a smooth interpolator function at least in part to determine a calibration function for that type of relevance scores. Examples of smooth interpolator functions may include one or more linear functions, polynomial functions, third order splines, or other monotonic splines interpolators, though, of course claimed subject matter is not limited to these examples. With regard to box 406, a system or process may determine one or more calibrated relevance scores based at least in part on the determined calibration function and one or more relevance function determined relevance scores of a corresponding type of file, document, or search result. In addition, a system or process may form one or more signals representing the calibrated relevance scores for the first type of the one or more relevance scores and store such formed signals in a memory device associated with the special purpose computing apparatus at box 408. In addition, a system or process may perform one or more of the functions for additional types of documents or files and their corresponding relevance scores. For example, a system or process may determine a calibration function for a variety of documents or files based at least in part on corresponding relevance scores and user rankings. In this example, a system or process may likewise form signals representing calibrated relevance scores based at least in part on the corresponding determined calibration function. With regard to box 410, a system or process may further execute instructions on the special purpose computing apparatus to transmit the one or more signals representing the calibrated relevance scores to a computing platform associated with a user via the electronic communications network. With regard to box 412, a system or process may further execute instructions on the special purpose computing apparatus to determine a combined ranking of the signals representing the calibrated relevance scores of both the first and second types of the one or more relevance scores. In addition, a system or process may determine a combined a blended ranking for documents or files of additional types at least in part by re-ranking search results based at least in part on determined calibration scores for those additional types of files or documents. Likewise, a system or process may transmit signals representing the combined or blended rankings via an electronic communications network to a computing apparatus associated with a user or a search query. It should, however, be noted that these are merely illustrative examples relating to calibrated relevance scores and that claimed subject matter is not limited in this regard.

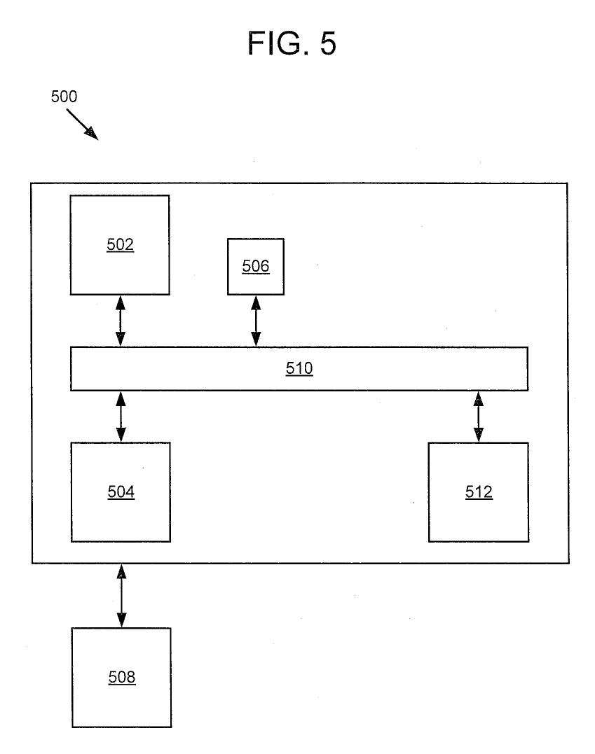

FIG. 5 depicts a schematic diagram of a special purpose computing platform in accordance with an embodiment 500. Embodiment 500 may comprise a computing apparatus or device, such as a special purpose computing apparatus having one or more processors programmed with one or more instructions to perform one or more particular functions and further adapted to receive relevance scores, one or more user rankings, determine one or more calibration functions, determine one or more calibrated relevance scores, and/or determine combined or blended rankings for documents or files of one or more types. In addition, embodiment 500 may comprise one or more processors programmed with one or more instructions to perform one or more specific functions, such as processor 502. For example, processor 502 may be programmed with one or more instructions to perform one or more specific functions, such as one or more ranking functions, one or more calibration functions, one or more re-ranking functions, and/or the like. Furthermore, embodiment 500 may comprise one or more memory devices, such as storage device 504 or computer readable medium 506. In addition, embodiment 500 may be operable to form one or more signals representing one or more determined, one or more determined calibrated relevance scores, one or more combined or blended rankings of the calibrated relevance scores, or the like. In addition, embodiment 500 may comprise one or more network communication adapters, such as network communication adaptor 508. In addition, embodiment 500 may be operable, at least in part in conjunction with network communication adaptor 508, to send or receive signals representing one or more actions such as one or more search queries, one or more relevance scores, one or more user rankings, one or more determined calibration functions, one or more determined calibrated relevance scores, and/or one or more combined or blended rankings of search results. Embodiment 500 may also comprise a communication bus, such as communication bus 510, operable to allow one or more connected components to communicate under appropriate circumstances. It should, however, be noted that these are merely illustrative examples relating to a computing apparatus and that claimed subject matter is not limited in this regard.

Some portions of the detailed description above are presented in terms of algorithms or symbolic representations of operations on binary digital signals stored within a memory of a specific apparatus or special purpose computing device or platform. In the context of this particular specification, the term specific apparatus, specific purpose computing device, special purpose computing apparatus, and/or the like may includes a general purpose computer or other computing device once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals and/or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” and/or the like refer to actions or processes of a specific apparatus, such as a special purpose computer, special purpose computing apparatus, or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding description, various aspects of claimed subject matter have been described. For purposes of explanation, specific numbers, systems or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method comprising:
receiving one or more signals representing one or more relevance scores associated with one or more search results from an electronic communication network;
executing instructions on a special purpose computing apparatus to:
determine a calibration function for a first type of the one or more relevance scores based at least in part on said first type of the one or more relevance scores and/or one or more user rankings of one or more of the search results corresponding to the first type of the one or more relevance scores;
form one or more signals representing calibrated relevance scores for the first type of the one or more relevance scores; and
store the formed one or more signals in a memory device associated with said special purpose computing apparatus.

2. The method of claim 1, and further comprising:
further executing instructions on said special purpose computing apparatus to: transmit the one or more signals representing the calibrated relevance scores to a computing platform associated with a user via said electronic communications network.

3. The method of claim 1, and further comprising:
further executing instructions on said special purpose computing apparatus to: determine another calibration function for a second type of the one or more relevance scores based at least in part on said second type of the one or more relevance scores and/or one or more user rankings of one or more of the search results corresponding to the second type of the one or more relevance scores; and form one or more signals representing calibrated relevance scores for the second type of the one or more relevance scores.

4. The method of claim 3, and further comprising: further executing instructions on said special purpose computing apparatus to: determine a combined ranking of the signals representing the calibrated relevance scores of both the first and second types of the one or more relevance scores.

5. The method of claim 1, wherein said determining a calibration function comprises interpolating a curve based at least in part on signals representing the first type of the one or more relevance scores and/or signals representing said one or more user rankings of the one or more documents corresponding to the first type of the one or more relevance scores.

6. The method of claim 5, wherein said forming one or more signals representing a calibrated relevance score comprises determining an adjusted value for the first type of the one or more relevance scores based at least in part on a difference between the determined calibration function for the first type of the one or more relevance scores and values of the first type of the one or more relevance scores.

6. An article comprising: a storage medium having stored thereon instructions that, if executed by a special purpose computing apparatus, enable said special purpose computing apparatus to:
read one or more signals representing one or more relevance scores associated with one or more documents from a memory device;
determine a calibration function for a first type of the one or more relevance scores based at least in part on said first type of the one or more relevance scores and/or one or more user rankings of one or more of the documents corresponding to the first type of the one or more relevance scores;
form one or more signals representing calibrated relevance scores for the first type of the one or more relevance scores; and
store the formed one or more signals in a memory device associated with said special purpose computing apparatus.

7. The article of claim 6, wherein said instruction, if executed by said special purpose computing platform, further enable said special purpose computing platform to:
determine said calibration function at least in part by interpolating a curve based at least in part on signals representing one or more user rankings of the one or more documents corresponding to the first type of the one or more relevance scores.

8. The article of claim 6, wherein said instruction, if executed by said special purpose computing platform, further enable said special purpose computing platform to:
form said one or more signals representing said calibrated relevance scores at least in part by comparing said relevance scores to the determined calibration function.

9. The article of claim 8, wherein said instruction, if executed by said special purpose computing platform, further enable said special purpose computing platform to:
determine an adjustment value for the one or more relevance scores based at least in part on a result of said comparing.

10. The article of claim 6, wherein said instruction, if executed by said special purpose computing platform, further enable said special purpose computing platform to:
transmit the one or more signals representing the calibrated relevance scores to a computing platform associated with a user via said electronic communications network.

11. The article of claim 6, wherein said instruction, if executed by said special purpose computing platform, further enable said special purpose computing platform to:
determine another calibration function for a second type of the one or more relevance scores based at least in part on said second type of the one or more relevance scores and/or one or more user rankings of one or more of the documents corresponding to the second type of the one or more relevance scores; and
form one or more signals representing calibrated relevance scores for the second type of the one or more relevance scores.

12. The article of claim 11, wherein said instruction, if executed by said special purpose computing platform, further enable said special purpose computing platform to:
determine a combined ranking of the signals representing the calibrated relevance scores of both the first and second types of the one or more relevance scores.

13. A system comprising:
a special purpose computing apparatus;
said special purpose computing apparatus comprising a network communication adaptor to receive one or more signals representing one or more relevance scores associated with one or more documents from an electronic communication network;
said special purpose computing apparatus further comprising one or more processors programmed with one or more instructions to:
determine a calibration function for a first type of the one or more relevance scores based at least in part on said first type of the one or more relevance scores and/or one or more user rankings of one or more of the documents corresponding to the first type of the one or more relevance scores;
form one or more signals representing calibrated relevance scores for the first type of the one or more relevance scores; and
store the formed one or more signals in a memory device associated with said special purpose computing apparatus.

14. The system of claim 13, wherein said one or more processors are further programmed to determine said calibration function at least in part by interpolating a curve based at least in part on signals representing one or more user rankings of the one or more documents corresponding to the first type of the one or more relevance scores and one or more smoothing functions.

15. The system of claim 14, wherein said one or more smoothing functions comprise one or more localized smooth interpolator functions.

16. The system of claim 15, wherein said one or more localized smooth interpolator functions comprise one or more spline functions.

17. The system of claim 15, wherein said one or more localized smooth interpolator functions comprise one or more monotonic spline functions at least in part to preserve an original ordering of said one or more documents corresponding to the first type.

18. The system of claim 13, wherein said one or more processors are further programmed to form said one or more signals representing said calibrated relevance scores at least in part by comparing said relevance scores to the determined calibration function.

19. The system of claim 18, wherein said one or more processors are further programmed to determine an adjustment value for the one or more relevance scores based at least in part on a result of said comparing.

20. The system of claim 13, wherein said network communication adaptor is further operable to transmit the one or more signals representing the calibrated relevance scores to a computing platform associated with a user.
